(19) United States
(12) Patent Application Publication
(10) Pub. No.: US 2009/0307207 A1
(43) Pub. Date: Dec. 10, 2009

(54) CREATION OF A MULTI-MEDIA PRESENTATION

(76) Inventor: Thomas J. Murray, Cohocton, NY (US)

Correspondence Address: EASTMAN KODAK COMPANY;PATENT LEGAL STAFF, 343 STATE STREET, ROCHESTER, NY, 14650-2201, US

(21) Appl. No.: 12/135,521

(22) Filed: Jun. 9, 2008

(51) Int. Cl. G06F 7/10; G06F 17/30

(52) U.S. Cl. 707/5; 707/E17.017

(57) ABSTRACT

A computer implemented method, computer system, and program storage device can be used for displaying images or videos simultaneously with a composition text that is read or sung. The displayed images or videos have been identified as related to selected words or phrases of the composition text and are displayed only when those selected words or phrases are read or sung in the accompanying audio playback. A number of techniques can be used to identify the appropriate images or videos for the selected words or phrases.

### FIELD OF THE INVENTION

The present invention relates generally to the automatic creation of Multi-media Presentations (“MMP's”). In particular, the present invention pertains to the automatic creation of a music and photo or video presentation using musical lyrics for timing a multiple image or video presentation, and to find images and videos that are semantically or otherwise suggestively related to the lyrics.

### BACKGROUND OF THE INVENTION

Multi-media slideshows have been utilized as a communication technique for decades, using photos, music, video and special transition effects to capture the attention of an audience and to entertain. Many software vendors have developed applications that create multi-media ‘slideshows’ by assembling a collection of images, videos and music and creating a video file that displays panning and zooming effects for images as music plays. In some of these cases, a computer application will analyze the music to determine the timing of the beat so that transition timing of the displayed images can be synchronized with the music. Some of these applications may also analyze the images to determine how best to zoom and pan. For instance, if there are multiple faces in an image scene, the application may zoom in on one face and then pan to the next face before transitioning to the next image. Most of these applications require that the user select the music, the titles/credits, and images in a particular sequence, and the videos in a particular sequence. After the application has finished composing all these elements according to a user's selections, the user is presented with a video file that can be played on various display systems such as DVD players/TVs, computers, digital picture frames, etc.

Many users start this multi-media creation process without knowing what sort of end product will result. What they know is that they have many pictures, images, and/or videos and they want to do more with them than merely display a static slideshow. Often, users select images and videos based on a number of factors such as memories, action shots, storytelling, quality, color, pride, etc. Selecting music that would fit the images sometimes can be difficult to do. The music might be too long or too short to match the quantity and timing of the image content. Users would like the images to appear when the particular words in music lyrics or in a poem, relating to the particular images are sung or read. For instance, when hearing the music and lyric line ‘Take me out to the Ballgame’ the user might like to see the image of a baseball field, and when hearing the lyric line ‘Take me out with the Crowd’ the user might like to see images of the fans in the stadium. In particular, a user would like to see images from a personal image collection displayed in an appropriate sequence and timing with the music lyrics.

Many users include generic instrumental music to avoid mismatching the lyrics with the particular images displayed. Otherwise, they must carry out a great deal of time consuming image sorting and video editing to enable the display of the images to match perfectly with the lyrics. This can lead to frustration with the process and abandoning an effort to create this form of presentation.

As the number of digital images continues to grow, there is considerable effort exerted in industry and academia on technologies that analyze image data to understand the content, context, and meaning of the media without human intervention. This area of technologies is called semantic understanding, and algorithms are becoming more and more sophisticated in how they analyze audiovisual data and non-audiovisual data, referred to as metadata, within a media file. For example, face detection/recognition software can identify faces present in a captured image. Speech recognition software can transcribe what is being said in a video or audio file, sometimes with excellent accuracy depending on the quality of the sound and attributes of the speech. Speaker recognition software is capable of measuring the characteristics of an individual's voice and applying heuristic algorithms to guess the speaker's identity from a database of characterized speakers. Natural language processing methods bring artificial intelligence to bear as an automated means for understanding speech and text without human intervention. These methods produce very useful additional metadata that often is re-associated with the media file and used for organization, search and retrieval of large media collections.

Karaoke software is capable of creating a lyric synchronization file (e.g. www.PowerKaraoke.com) of a song. A user can import text lyrics and its corresponding music to a desktop Personal Computer (PC) and synchronize the display of the text (lyrics) with the music. After the user has created the synchronization the user can export a lyric synchronization file, which would include a timestamp for each word contained in the lyrics. For example, MIDI (Musical Instrument Digital Interface) is an industry-standard protocol that enables electronic musical instruments, computers and other equipment to communicate, control and synchronize with each other. Sync signals from the MIDI file allows multiple systems to start/stop at the same time and keeps their playback speeds consistent. The sync signal can be used to synchronize music to video. MIDI does not transmit an audio signal or media - it simply transmits digital data “event messages” such as the pitch and intensity of musical notes to play, control signals for parameters such as volume, vibrato and panning, cues and clock signals to set the tempo. MIDI-Karaoke (which uses the “.kar” file extension) files are an extension of MIDI files, used to add synchronized lyrics to standard MIDI files. Music players play the MIDI-Karaoke music file and display the lyrics synchronized with the music in “follow-the-bouncing-ball” fashion, essentially turning any PC into a karaoke machine.

Several websites provide lyric synchronization files to support Karaoke applications. Users simply search for the title and the artist information and download the lyric synchronization files. Users may also create their own lyric synchronization files by obtaining lyric texts in hardcopy or electronic form and using a software application to make the lyric synchronization files. Lyrics may also be obtained directly from music publishers or websites such as LyricList™ or Seekalyric™.

### SUMMARY OF THE INVENTION

This invention provides a computer implemented method for producing a multimedia presentation, comprising the steps of:

providing to a computer system, text of a composition that is read or sung in a corresponding audio file,

automatically searching metadata associated with media to identify those media that correspond to at least one word or phrase of the composition text, wherein the identified media comprises video and still images, and

automatically simultaneously displaying the identified media while playing the corresponding audio file.

In addition, this invention provides a computer system comprising:

storage for text of a composition that is read or sung in a corresponding audio file, the corresponding audio file stored in the storage, wherein the storage also stores a plurality of media each having associated metadata stored therewith, and wherein the media comprise video and still images,

a programmed processor for searching the metadata associated with the media to identify those media that correspond to at least one word or phrase of the composition text, and

a display device under control of the programmed processor for simultaneously displaying the identified media while playing the corresponding audio file.

This invention also provides a program storage device readable by a computer that embodies a program of instructions executable by the computer to perform method steps for generating a multimedia presentation, said method steps comprising:

reading and storing text of a composition that is read or sung in a corresponding audio file,

automatically searching metadata associated with media to identify those media that correspond to at least one word or phrase of the composition text, wherein the identified media comprises video and still images, and

automatically simultaneously displaying the identified media while playing the corresponding audio file.

Starting with music lyrics (text), or a written work such as a poem, an embodiment of the present invention can automatically create a compelling multi-media presentation that displays images and/or videos at the relevant time while music is playing—synchronizing the image assets with the music lyrics key words and phrases. For example, a music lyric may say ‘Take me out to the Ballgame’ which will trigger displaying a baseball diamond picture or video. The user only has to select the music and does not have to select the image assets (i.e. still images, videos, graphics) and does not have to synchronize the images with the music. One embodiment of the invention automatically analyzes the lyrics, the musical score, and the image metadata to determine which images and videos best match the particular lyric word or lyric phrase. A timeline or ‘storyboard’ will be created that will position the images on the timeline to synchronize with the time that the lyric word or lyric phrase is sung or spoken. This method frees the user from the video editing step and provides a much more compelling output product than prior video making applications. In addition, a user does not have to search a personal collection for images and videos that would fit a selected music piece.

Another embodiment of the present invention is a method to automatically select appropriate video or images to be used in a multi-media presentation based on lyrics contained in selected music or words contained in a written work of authorship. Optionally, appropriate video or images can be selected based on detected emphasis placed on each word or phrase within the music or spoken work. The lyrics or text of a written composition text are stored on a computer system and the words or phrases selected therefrom are used to search metadata associated with corresponding video or images stored on the computer system. The searching can also be performed remotely over a network or network-connected devices that are used to store and make available multimedia assets. For example, the network or network-controlled devices can be connected to a computer system being used to practice this invention.

Thus, one embodiment of the invention displays the appropriate images (that is, identified media) at the time the corresponding lyrics are played or word or phrase is spoken in the multi-media presentation, for example, on a display device that is coupled to a computer system. After the media assets are identified and timed, they are displayed on the computer system simultaneously while playing a music audio file or an audio file containing a spoken work. If a number of media assets are available, they can be ranked according to various metrics such as relevance to the text or media, or according to a quality of the images or video, or both. The higher ranked media assets can be given priority over lower ranked assets. Words and phrases in the lyrics and text can also be rated according to their emphasis, which can be measured according to semantic emphasis, vocal emphasis (e.g. duration, loudness, or inflection), or an amount of repetition. Words that appear in a title of the work may be given a separate priority.

Still another embodiment of the present invention comprises a computer system having either permanent or removable memory or storage for storing text of a composition that is read, or lyrics that are sung, in a corresponding audio file that is also stored in the memory or storage of the computer system. A number of media assets, which may be video or image assets, each having associated metadata area also stored on the computer system. A computer system processor executes a program for searching the metadata to identify associated assets that correspond to at least one word or phrase of the lyrics or text of a musical or written composition. A computer system display under control of the processor simultaneously displays the identified media assets while playing the corresponding audio file on speakers that are under control of the computer system.

Other embodiments that are contemplated by the present invention include computer readable media and program storage devices tangibly embodying or carrying a program of instructions readable by machine or a processor, for having the machine or computer processor execute instructions or data structures stored thereon. Such computer readable media can be any available media that can be accessed by a general purpose or special purpose computer. Such computer-readable media can comprise physical computer-readable media such as RAM, ROM, EEPROM, CD-ROM, DVD, or other optical disk storage, magnetic disk storage or other magnetic storage devices, for example. Any other media that can be used to carry or store software programs which can be accessed by a general purpose or special purpose computer are considered within the scope of the present invention.

These, and other, aspects and objects of the present invention will be better appreciated and understood when considered in conjunction with the following description and the accompanying drawings. It should be understood, however, that the following description, while indicating particular embodiments of the present invention and numerous specific details thereof, is given by way of illustration and not of limitation. Many changes and modifications may be made within the scope of the present invention without departing from the spirit thereof, and the invention includes all such modifications. The Figures described below are not intended to be drawn to any precise scale with respect to size, timing, angular relationship, or relative position.

### BRIEF DESCRIPTION OF THE DRAWINGS

FIG. 1 is a block diagram of a computer system capable of practicing various embodiments of the present invention.

FIG. 2 illustrates MMP Database Lyric entries.

FIG. 3 illustrates MMP Database Image metadata entries.

FIG. 4 illustrates a flowchart of a method to associate Images with Lyrics in the MMP Database.

FIG. 5 illustrates MMP Database Lyric to Image relationship entries.

FIG. 6 illustrates a flowchart of a method to create the MMP from the music, lyrics, timestamp and images.

FIG. 7 illustrates an example of lyric keyword ranking.

### DETAILED DESCRIPTION

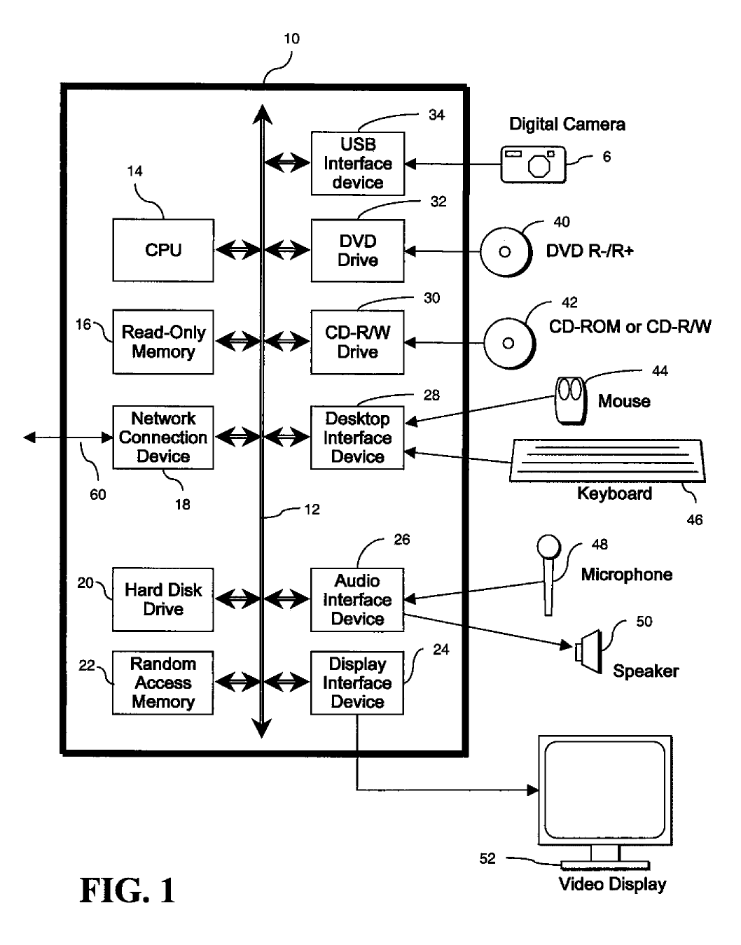

FIG. 1 illustrates one example system for practicing an embodiment of the present invention. In this example, the system includes a computer 10 that typically comprises a keyboard 46 and mouse 44 as input devices communicatively connected to the computer's desktop interface device 28. The term “computer” is intended to include one or more of any data processing device, such as a server, desktop computer, a laptop computer, a mainframe computer, a router, a personal digital assistant, for example a Blackberry* PDA, or any other device for computing, classifying, processing, transmitting, receiving, retrieving, switching, storing, displaying, measuring, detecting, recording, reproducing, or utilizing any form of information, intelligence or data for any purpose whether implemented with electrical, magnetic, optical, biological components, or any combinations of these devices and functions.

The phrase “communicatively connected” is intended to include any type of connection, whether wired, wireless, or both, between devices, and/or computers, and/or programs in which data may be communicated. The phrase “communicatively connected” is also intended to include a connection between devices or programs within a single computer, a connection between devices or programs remotely located in different computers, and a connection between or within devices not located in computers at all.

Output from the computer 10 is typically presented on a video display 52, which may be communicatively connected to the computer 10 via the display interface device 24. The video display 52 may be any suitable display device such as a display device that is part of a personal digital assistant (PDA), cell phone, or digital picture frame, or such display device may be a digital projector or monitor. Internally, the computer 10 contains components such as CPU 14 and computer-accessible memories, such as read-only memory 16, random access memory 22, and a hard disk drive 20, which may retain some or all of the digital objects referred to herein.

The phrase “computer-accessible memory” is intended to include any computer-accessible data storage device, whether volatile or nonvolatile, electronic, magnetic, optical, or otherwise, including but not limited to, floppy disks, hard disks, Compact Discs, DVD's, flash memories, such as USB compliant thumb drives, for example, ROM's and RAM's.

The CPU 14 communicates with other devices over a data bus 12. The CPU 14 executes software stored on, for example, hard disk drive 20, an example of a computer-accessible memory. In addition to fixed media such as a hard disk drive 20, the computer 10 may also contain computer-accessible memory drives for reading and writing data from removable computer-accessible memories. This may include a CD-RW drive 30 for reading and writing various CD media 42 as well as a DVD drive 32 for reading and writing to various DVD media 40. Audio can be input into the computer 10 through a microphone 48 communicatively connected to an audio interface device 26. Audio playback can be heard via a speaker 50 also communicatively connected to an audio interface device 26. A digital camera 6 or other image capture device can be communicatively connected to the computer 10 through, for example, the USB interface device 34 to transfer digital objects from the camera 6 to the computer's hard disk drive 20 and vice-versa. Finally, the computer 10 can be communicatively connected to an external network 60 via a network connection device 18, thus allowing the computer to access digital objects and media assets from other computers, devices, or computer-accessible memory communicatively connected to the network. As sometimes referred to herein, a “computer-accessible memory system” may include one or more computer-accessible memories, and may be a distributed data-storage system including multiple computer-accessible memories communicatively connected via a plurality of computers, a network, routers, or other devices, or a combination thereof. Alternatively, a computer-accessible memory system need not be a distributed data-storage system and, consequently, may include one or more computer-accessible memories located within a single computer or device.

A collection of digital objects and/or media assets can reside exclusively on the hard disk drive 20, compact disc 42, DVD 40, or on remote data storage devices, such as a networked hard drive accessible via the network 60. A collection of digital objects can also be distributed across any or all of these storage locations.

A collection of digital objects may be represented by a database that uniquely identifies individual digital objects (such as a digital image file) and their corresponding location(s). It will be understood that these digital objects can be media objects or non-media objects. Media objects can be digital still images, such as those captured by digital cameras, digital video clips with or without sound. Media objects could also include files produced by graphic or animation software such as those produced by Adobe Photoshop™ or Adobe Flash™. Non-media objects can be text documents such as those produced by word processing software or other office-related documents such as spreadsheets or email. A database of digital objects can be comprised of only one type of object or any combination of objects. Once a collection of digital objects is associated together, such as in a database or by another mechanism of associating data, the objects can be abstractedly represented to the user in accordance with an embodiment of the present invention.

To provide a compelling presentation, various embodiments of the present invention pertain to a system and method to synchronize images or videos, or combinations thereof, with a musical or otherwise lyrical piece. Identified and emphasized words or phrases within the music lyrics are timed and matched with displayed images or videos. Key words within the lyrics are identified so that the meaning of the song and spoken work is projected through the images that are displayed. Through the use of natural language processing techniques it is determined which of the words and phrases of the lyrics contain the most “meaning”. For instance, nouns, names, verbs, etc. can be identified and more emphasis can be placed on those words than on adjectives, adverbs, etc. Analyzing pitch, vibrato, and inflection of the words can determine emphasis and emotion.

Lyrics can also be split into phrases or verses, generally from three to ten words, so that the entire phrase can trigger the display of a particular image asset. The phrases may be selected based on detecting a long delay between words that would delineate connected words within a phrase versus a gap between phrases, or phrases can be derived from the musical score.

An additional technique is to detect the vocal emphasis as read or sang, for example, by the inflection of the artist's voice for emotional content and importance of a song lyric or a phrase within a poem. Voice recognition applications have the ability to detect inflection in order to detect questions, or exclamations to properly annotate the punctuation of the voice. From this information (punctuation), the appropriate emphasis can be determined on a word-by-word or phrase-by-phrase basis. Such operations can be provided from a program of instructions that is in the computer system or available on a program storage device (e.g., computer-accessible memory system) that is readable by a computer.

Musical scores provide additional information for emphasis. A musical phrase may be marked as ‘loud’ (staccato, crescendo, and other musical dynamics, etc.) in the musical score. The duration of a note (and corresponding lyric) can also determine its importance. A note/lyric with a long ‘beat’ (or held for multiple measures) is much more likely to be a key word of the song than one that is marked with a ‘half beat’ (or single measure). Also, words at the end of a phrase are likely to be key words since they will likely be used to rhyme with other phrases within the song as opposed to other words buried within the phrase. Words at the end of the phrase are also likely to be emphasized to accentuate the syllables of the words of the rhyming phrases.

Additional techniques can be used to determine lyric/word importance such as detecting a ‘chorus’ or repeating phrase so that the more that a phrase is repeated, the more likely it is an important phrase. Therefore, counting a number of occurrences of the key words or key phrases in the composition text will help to determine it's importance ranking. Also, if the word or phrase is contained within the title of the song, it is likely to be important. Developing a list of synonyms and antonyms from the key words of the song title will help to find key words within the lyrics. The song title is likely to convey an overall meaning to the song and any words related to it should be important. In some cases, it may be the synonyms of the title words and in other cases it may be the antonyms that are important. Other criteria can be used that address the emphasis desired in the musical score. The musical score is analyzed for dynamic markings that indicate if the particular section of music or lyric is to be sung ‘loud’. Dynamic marks such as Mezzo-forte (i.e. Medium loud) or Fortissimo (i.e. as loud as possible) would have a higher importance score than sections of the music that are marked with Pianissimo (i.e. Very soft volume).

These and other natural language processing techniques can be used to determine which words to emphasize. Moreover, these techniques can be provided in the program of instructions provided to a computer, from a network, or on a program storage device or system that is readable by a computer.

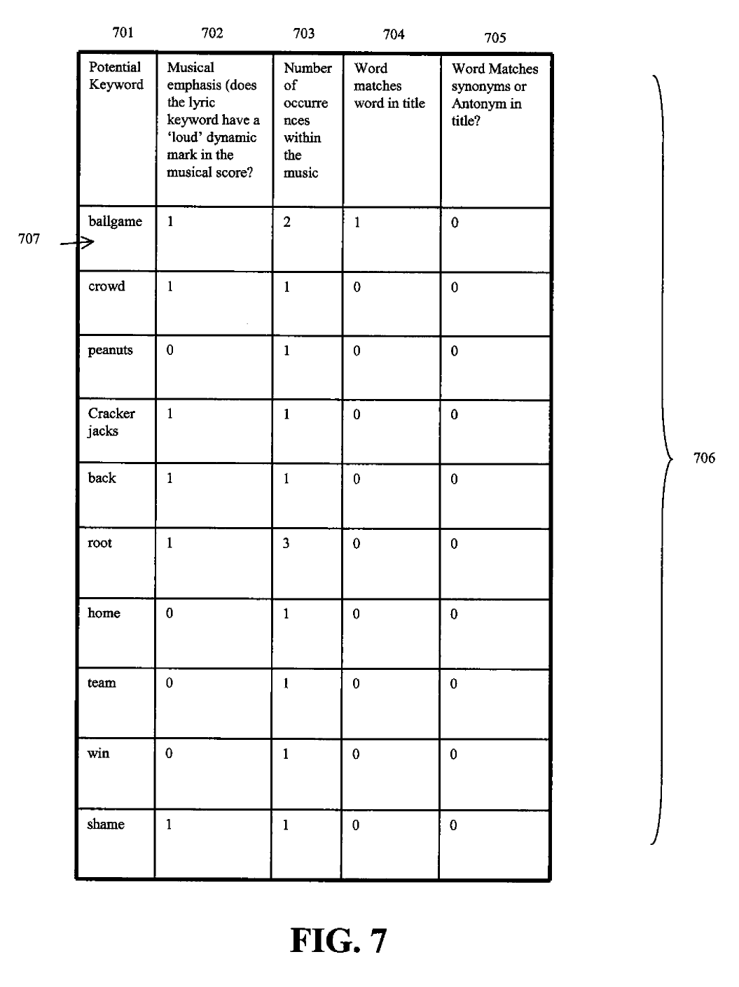

A potential key word may be found in a set of lyrics (also referred to herein as “composition text”) by first using natural language processing to pick out the nouns as well as selecting of all the words appearing at the end of a lyric phrase. Each of these potential key words can be used as lyric key words but it may be desirable to rank the key words to help emphasize some over others to present a more meaningful multi-media presentation. By way of example of this embodiment, see FIG. 7. A simple method is to assign a value to each of the criteria that determine the importance of a potential keyword. The ‘dynamic mark’ criteria 702 has a value of 1 or 0 depending on the type of dynamic mark. For all dynamic marks that fall into the ‘loud’ category (e.g. Forte, Fortissimo, etc.) the criteria value can be 1, but for ‘soft volume’ categories (e.g. Piano, Pianissimo, etc.) the criteria value may be 0. The next criterion 703 represents counting the number of times the word or phrase occurs within the composition text. The next criteria 704 value is 1 if the potential key word or phrase exactly matches a word or phrase in the title, but otherwise it is 0. The next criteria 705 looks for direct matches of the synonym and antonyms of the title words. So a value of 1 is set for any potential keyword that matches a synonym or antonym of any title word. For this example, the song title is ‘Take Me Out to the Ballgame’ and the first potential key word is shown in the first column 701. The dynamic mark 702 criteria value for ‘Ballgame’ 707 is set to 1 based on the musical score dynamic mark (i.e. meaning the word ‘ballgame’ is meant to be sung loud relative to other words). The next criteria ‘number of occurrences’ 703 is 2 since the word ‘ballgame’ appears twice. The next value, ‘word in title matches’ 704 is 1 because ‘ballgame’ appears in the title as a direct match. And synonym/antonym criteria 705 is 0 because the synonyms for ballgame are not likely to produce ‘ballgame’ again. Overall, the potential key word ‘ballgame’ would be given a score of 4 by adding up each of the criteria values (Columns 702, 703, 704, 705). This same addition can be performed on each of the potential keywords. Those with the highest scores have the highest importance. Of course there is likely to be many ‘ties’ using this scheme and thus a further refinement to the accuracy of the keyword importance could be to assign a weight multiplier to each of the criteria. Some criteria may be considered more important than others and it may be desirable to include a weighted multiplier to each of the criteria values before calculating the importance score.

The techniques described above can be used separately or together in any combination to determine the most important and impactful lyric key words. A low score would indicate the words within the Lyric do not directly relate to the ‘meaning’ of the lyric but are needed to construct the sentence (e.g. connecting words, and short non-descriptive words). A threshold minimum importance score is utilized so that any words or phrases that have a low importance score will not be included in the query searches.

It is understood that more sophisticated means could be used to determine a better and more correlated ranking of the lyric key words using fuzzy logic, inference, and other semantic technologies. These descriptions are merely representative means for ranking of words or phrases.

An embodiment of the present invention utilizes the importance and emphasis of particular lyrics and phrases to provide a rating, or score, for each lyric or phrase. Utilizing the techniques described above, the ratings will be applied to each word and each phrase within the lyrics. It is recognized that there are many other techniques for scoring/ranking words within a written work such as those described in U.S. Pat. No. 6,128,634 (Golovchinsky, et al.) that describes an algorithm that scores words contained in a written work.

The described techniques for automatically identifying the key words and key phrases within the composition text can be incorporated into a software routine, which is identified as a Lyric Processing Engine. The Lyric Processing Engine will automatically identify the Lyric KeyWords/phrases 402 and populate within a database that is called the autoMMP (automatic Multi-Media Presentation) database 403. This autoMMP database 208 contains the associations for each word and each phrase in the lyric with timing data, image data and importance scores.

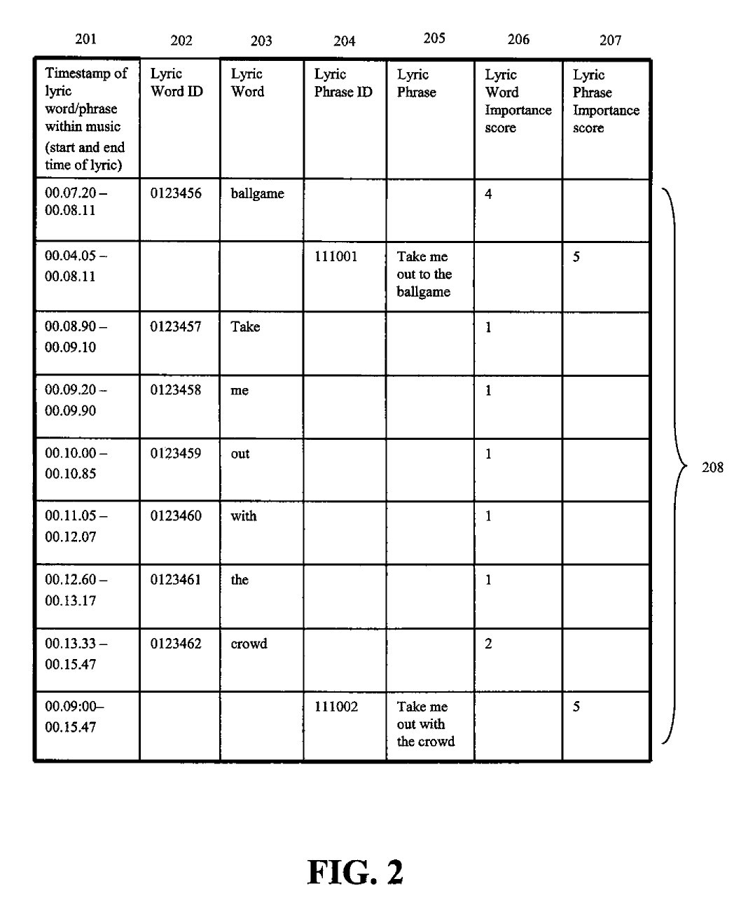

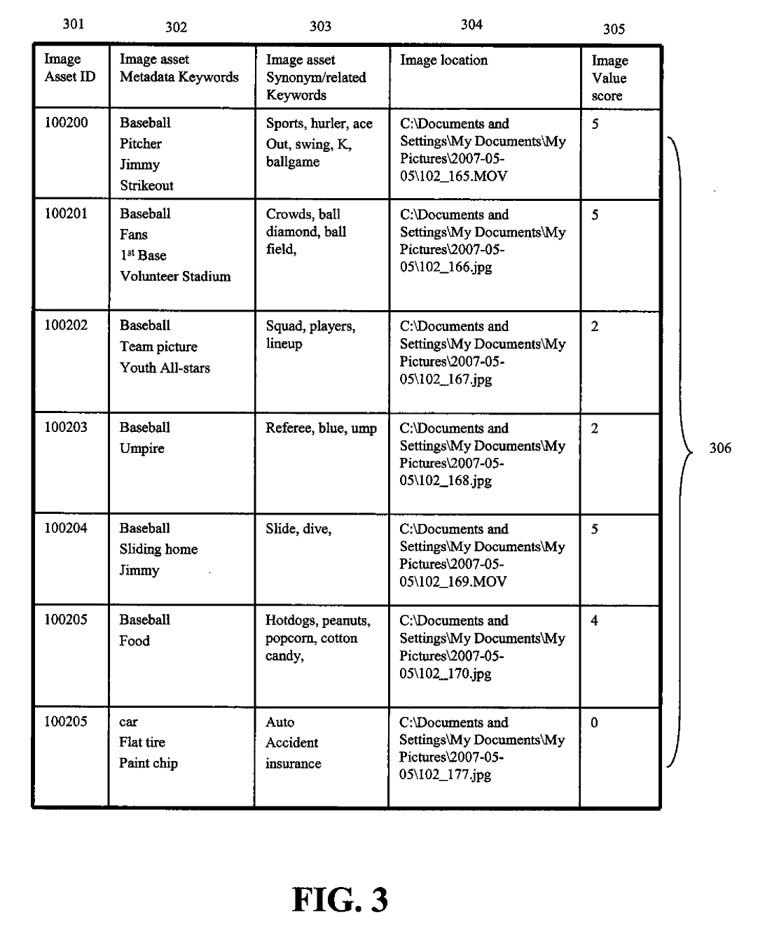

The following is an example of the contents in the autoMMP database as exemplified in FIGS. 2 and 3:

The time stamp for each word 201.

The start and stop times of each word as it is to be sung in synchronization with the musical score 201.

The start and stop time of each phrase 201.

The Lyric IDs (for both lyric words and lyric phrases) 202, 204.

The text of each word and phrase 203, 205.
Note: repeating lyric key words and key phrases are treated as separate entries in the database.

The importance score for each word and each phrase of the lyrics 206, 207.

The image ID of the image assets 301.

The image metadata (which includes keywords describing the scene contents of the image asset) 302.

The image keyword synonyms 303.

The image location within the computer file system 304.

The image value score 305.

It will be understood that selecting key words is not limited to the English language, or any language that has definable characters representing words. The method of this invention can be used with images and phrases in any language. In addition, the invention can be adapted to identify appropriate symbols of symbolic languages such as the Hebrew, Japanese, and Katakana languages.

To determine which media (e.g., still images, videos, or both) to correlate with particular lyric words or phrases, the key words associated with the media are determined or identified based at least upon metadata associated with such media, (It should be noted that the phrase “image asset” and the term “image” are used interchangeably herein with the term “media”). There are many imaging applications that allow users to manually select key words to ‘tag’ media, i.e., add keywords to the media's metadata. Websites such as Flickr.com encourage users to tag images with key words to aid in sharing and searching for images. These key word tags can include names of persons depicted in the scene or picture (e.g. people names, team name, group name), places or location, captions, event names (e.g. Christmas, birthday, vacation, etc.), objects that may be in the scene or other attributes (e.g. mud, cute, colorful, sad, etc.). Also, algorithms are being developed to automatically tag images with information provided by algorithms such as face detection and recognition, and object detection and recognition. Capture devices automatically populate image files with metadata such as date/time of capture, location coordinates, scene detection, and other metadata. These tags will be written to appropriate locations within the media files using the Exif or XMP or other image file specifications that accommodate metadata.

Image metadata can be imported into a database 308 to allow easy access and retrieval of the information. A user's entire collection of images and associated metadata can be contained within a database and can be queried to obtain the key words associated with each particular image asset. Some of the key words will indicate the location, the name of the event, the people, the time and date when the image was captured, object names contained within the scene, and many other words that will be helpful to understand what the image asset is about. Each image asset will have an entry in the autoMMP database 308 with the Image ID 301 and the associated image asset key words 302.

The autoMMP database now has the necessary elements to allow an application (i.e. autoMMP application) to automatically associate image assets to lyrics.

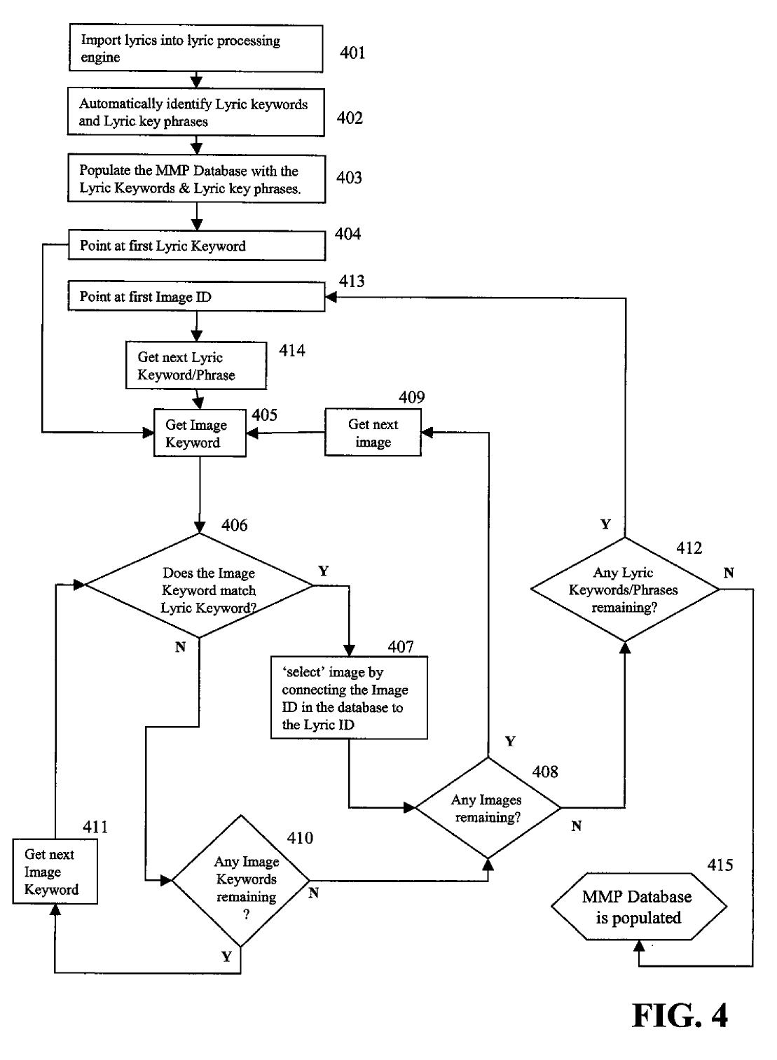

The autoMMP application will query the database to find image assets that match specific lyric key words and phrases (see FIG. 4). A song about baseball will have many words about the baseball playing experience (e.g. “baseball”, ‘pitch’, “hit”, “mitt”, “bat’, “diamond”, “running”, “bases”, etc.). The user, having selected this song, will likely have many images, pictures, or videos that depict a baseball scene (e.g. baseballs, mitts, ball diamond, bats, etc.). In this example, correlating the pictures to the lyrics is somewhat straightforward. The autoMMP application will locate the first Lyric keyword 404 and then locate the first Image keyword 405. A comparison is made to see if the Lyric keyword matches the Image keyword 406. If there is an exact match then the Image ID 503 of the particular image is associated with the Lyric ID 501 in the database 407. A lyric that emphasizes ‘baseball’ will likely find multiple image assets tagged with the word ‘baseball’. The image ID 301 of every image asset that is associated with the lyric key word will be recorded in the database. This process continues for the next selected lyric key word until all the lyric key words and lyric phrases have been queried. Therefore, for each Lyric Keyword/phrase all the image asset keywords will be queried, a check is made to determine if any images remain 408. If not, a check is made to see if any lyrics remain 412. If so, the process starts over by obtaining the first image asset 413 and obtaining the next Lyric keyword/phrase 414. Each image may have several keywords so a check is made to exhaust all the keywords within an image asset 410 and then increment through each one 411 to determine if they match 406 the Lyric keyword or phrase. When each Lyric key word and key phrase has been checked 412 the autoMMP database is now populated with the association of the lyric key words to the corresponding image assets 415.

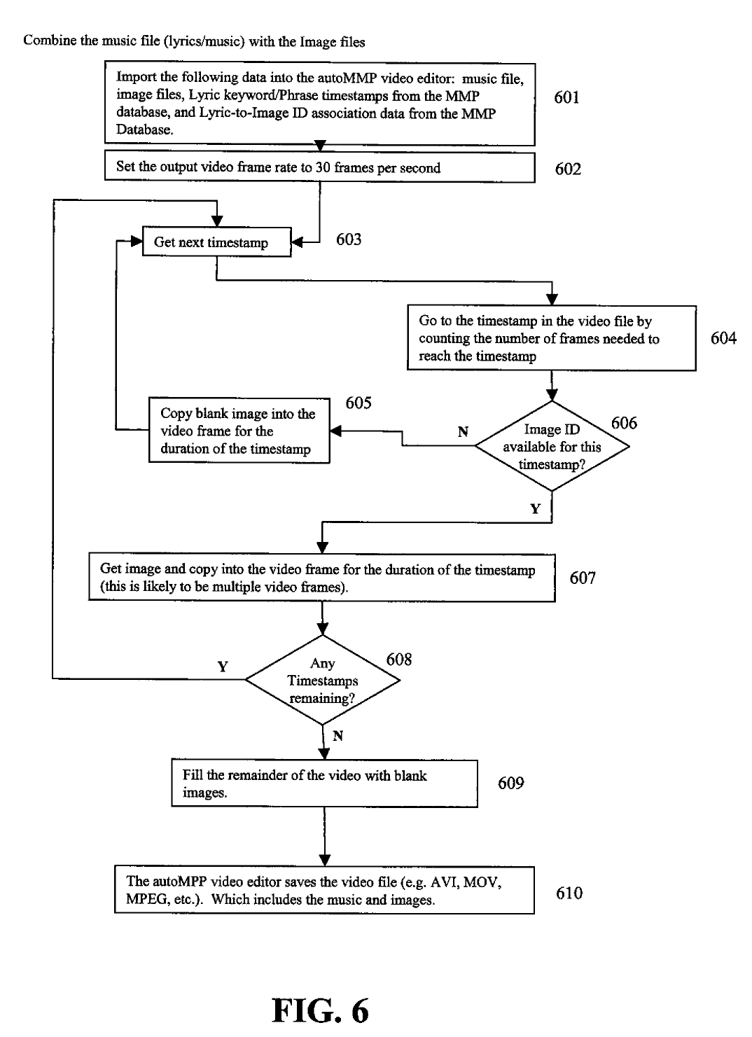

In some cases there may be no image asset key words that directly match the lyric key words so a second round of selection can be performed by the autoMMP application. The image asset key words may be analyzed to create a list of synonyms to increase the chances of matching lyric key words. If there are no image assets available that match the lyric key words then blank images can be used, as is the case of our example in FIG. 6 605 or the application can query an external set of image assets. These image assets can be retrieved from public stock photo websites or online photo services, or clipart websites such as Google™ image and Flickr™. Therefore, if there are no pictures of ‘CrackerJacks,’ for example, then a query to a Google image could retrieve images that are tagged with ‘crackerjacks.’ Similar techniques can be applied for determining image value and image quality to ensure that they are rated high enough to place in the final multi-media presentation.

The identified media can be ranked based on a number of criteria including but not limited to the following criteria:

the strength of the identified media's relevance to at least one word or phrase in the composition text,

the quality of the identified media, or

both the strength of the identified media's relevance to at least one word or phrase in the composition text and the quality of the identified media.

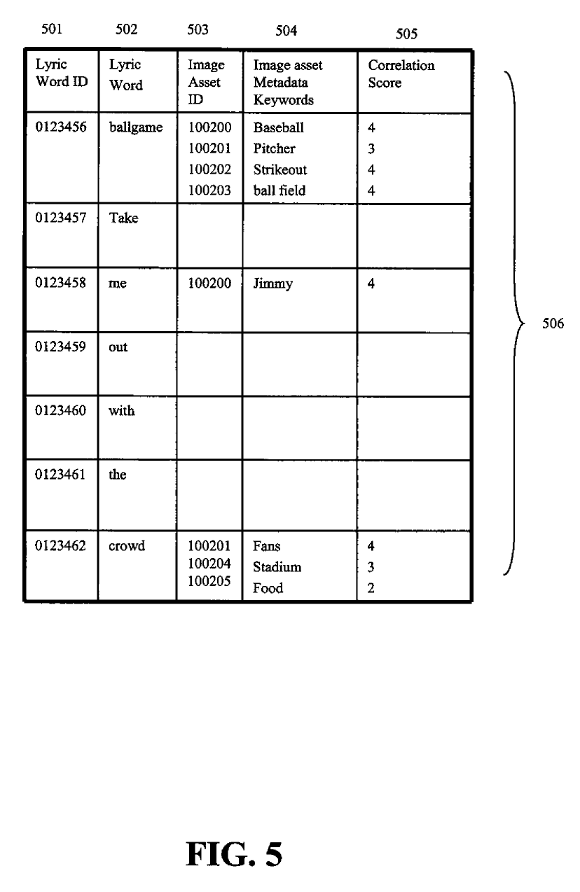

In some cases, there may be multiple image assets for each lyric key word 504. FIG. 5 shows a portion of the autoMMP database that includes the association of the Lyric ID 501 with the Image ID 503 and the corresponding Lyric keywords 502 and Image keyword 504. A correlation ranking, or rating, process can be implemented where the strength of the association (i.e., relevance) of the Lyric Keyword to the Image Keyword is determined. If the correlation strength is high (i.e. the key word for the image is a direct match for the key word in the lyric, or multiple image asset key words match multiple lyric key words) it is given a high correlation (i.e., relevance) score 505 (e.g. for a scale of 1 to 5 it would be a 5). Where there is a weak correlation between the key word in the image and the key word in the lyric it can be given a low correlation (i.e., relevance) score, or rating. For instance, a low correlation score may result when a direct match between the image key word and the lyric key word is not obtained but a synonym for each word results in a match. The user may exercise a threshold correlation score for their multi-media presentation by considering only those assets whose threshold correlation score is at or above the thresholds. This would eliminate the use of image assets that did not have high association with any of the lyrics or phrases.

Image assets may be further scrutinized for inclusion in the final multi-media presentation by analyzing the value level of the image. An image value index (“lVI”) is defined as a measure of the degree of importance (significance, usefulness, or utility) that an individual user might associate with a particular asset, and is described in detail in U.S. Patent Application Publication 2007/0263092 (Fedorovskaya et al.) and in copending and commonly assigned U.S. patent application Ser. No. 11/403,583, file Apr. 13, 2006.

Automatic IVI algorithms can utilize image features such as sharpness, lighting, and other indications of quality. Camera-related metadata (exposure, time, date), image understanding (skin or face detection and size of skin/face area), or behavioral measures (viewing time, magnification, editing, printing, or sharing) can also be used to calculate an IVI for any particular media asset. For instance, if the particular image has a low image value index then it would not rank as high as other image assets with the same key words. Also, images may have more value if they contain people so ranking these images higher than non-people images is practical. Using these and other criteria the application determines an image's value relative to other images. The image value scores can be included in the autoMMP database 305.

The multi-media presentation can be a video file that includes music, still images and video images. The image assets are to be displayed at particular times that are appropriate based on the musical score and the timeline of the lyrics. The length and duration of display of the images (“display durations”) is determined by the length and duration of the lyric as it is performed and when the next key word (identified media) is sung in the lyric or spoken in a poetic work.

The autoMMP video editor is a software application that queries the MMP database for the information needed to create the multi-media presentation (see FIG. 6). The AutoMMP video editor creates a video file by importing the music (which includes the lyrics, instrumentals, and performer's voice), and importing the image assets that have been identified in the MMP database 601 and importing the timestamps for each of the Lyric keywords/phrases. At specific timestamps, which are data elements that indicate when an event is to start and stop within a video or music file. They can be determined by the minute, second and frame from the music file. Where each keyword has it's own timestamp 201 which represents the relative time that has passed from the start of the music. The autoMP video editor combines the audio music file with the image assets. A video file is made up of a series of ‘frames’ that when played back in a particular sequence and speed will provide the animation desired. In this example we are setting the frame rate to 30 frames per second 602. The music will be interleaved with the video frames so that it plays simultaneously with the video frame images. The timestamp can be predefined by the database entries or modified by the user and is obtained by the autoMMP video editor 603. The autoMMP video editor determines which frame corresponds to the next timestamp by counting the number of frames needed to reach the timestamp 604. Frame counts can be determined by multiplying the minute/second of the timestamp by the frame rate. When the timestamp of the first key word has been determined, a “get image1” command 607 is generated and sent through the autoMMP video editor to compose the video file. The image file path of the image asset is located in the autoMMP database 304. When the timestamp of the second lyric key word is reached, a “get image2” command is generated and sent through the autoMMP video editor to compose the next section of the multi-media presentation, which will display the second image associated with the phrase when the multi-media presentation video file is played back. Multiple frames of the same image are needed in sequence to create the video effect. The selected image will be used for multiple frames as the duration of the lyric timestamp specifies. When the duration of the lyric has ended a new image may be selected or some type of effect or transition will be displayed before the next timestamp occurs. This process is repeated until no more timestamps are available 608. Finally, the remainder of the frames (if there are any remaining) to complete the video are filled with blank images. The autoMMP video editor will use standard compression and video composing techniques to create the desired video output format (e.g. .MOV, AVI, MPEG, etc.) that will compile the music and images 610.

Optionally, a plurality of images can be displayed that relate to the same Lyric key word until the next significant key word is sung or spoken. The phrase and word duration time determines how many image assets can be displayed for that particular word or phrase. The plurality of these equally important images can appear simultaneously and randomly in a collage format. Optionally, a plurality of images can be displayed in a sequential order where the first priority image appears and then next highest priority and so on until the image assets are exhausted or the next key word lyric timestamp appears. To provide a more artistic effect, a displayed image may linger or dwell past the completion of the sung word or phrase. Dwelling on a particular image can also be dependent on when the next word or phrase appears. A calculation can be made to determine the gap between key words and phrases. As a new key word appears the previous image can be removed before the new image appears. A fixed time can be programmed into the system to halt the display of images after a specified time period.

The user may set a threshold to limit the number of times an image asset can be used. Image assets can be prioritized within the database such that the highest priority image asset is chosen first for the lyric key word. Priorities can be established by analyzing the image Value score 305 as well as the correlation score 505 of the image to the lyric.

Some lyric key words and lyric phrases repeat within a song. The image assets that are associated with a particular instance of the lyric key word or phrase may be identical to other instances of the lyric key word or phrase. The images can be displayed in the exact same sequence and timing to match the music. Optionally, this may not be desirable so variations may be included in the subsequent image asset display. To provide variation a count can be created to count the number of times a particular image asset has been used within the multi-media presentation. If it has been used at least once then the next highest priority image asset can be used when called upon. If no additional image assets are available then the system can cycle back to the highest priority image asset and cycle through the prioritized assets until the completion of the multi-media presentation.

It may also be desirable to display images related to the music but not associated with a particular lyric. In many musical compositions there are periods of time where there are no lyrics and only instrumental performances. This ‘lull’ in lyrics provides an opportunity to display a montage of images that may not have had high correlation with a particular lyric but do have high correlation with the overall meaning of the song. A synopsis about a song can be obtained from websites such as About.com, Burstlabs.com, and NPR.org. These sites provide reviews, key words, descriptions and genre for many popular songs and music. For instance, there may not be any lyrics in the song ‘Take me out to the Ballgame’ that refer to a baseball team mascot, bases, baseball equipment, etc., but these words do generally relate to the song. The instrumental portion of the song affords the multi-media presentation an opportunity to display the related imagery of a baseball team mascot, bases, baseball equipment, etc.

To add variety to a multi-media presentation the timing of the particular image to be displayed may not occur on each lyric word but instead variations such as immediately before the lyric timestamp, exactly on the lyric timestamp, or between the lyric timestamps. Some special effect transitions such as fading or dissolving images may be appropriate depending on the music or lyric. For instance, as the music fades the image may be programmed to fade as well. To develop an overall theme for the multi-media presentation, transitions can be selected for the type of music. For dramatic and emotional music, image transition techniques such as Fade, Color fade, or slow transition can be used. For exciting or action packed music, image transition techniques such as spiral, fly, zoom, or fast transition image effects can be programmed for selection. For fanciful or fun music, image transition techniques such as color effects, spiral, zoom, and random transition image effects can be used.

Each effect is picked by the autoMMP video editor depending on the attributes of the overall song and the individual words and phrases within the song. The attribute of the overall song is determined by analysis of the Mood and Theme of the song. This information can be obtained from multiple websites such as About.com, Burstlabs.com, and NPR.org. These sites provide reviews, key words, descriptions and genre for many popular songs and music. Some examples of Moods include Warm, Amiable, Earnest, Slick, yearning, reflective, wistful, and dramatic. Examples of Themes include introspective, drinking, reminiscing, feeling blue, and reflection. These types of key words can help to set the overall ‘look’ of the multi-media presentation such as the graphics and framing of the presentation as well as selection of user images to include in the multi-media presentation.

The multi-media presentation could be a photobook. The photobook would contain text of a song or poem along with a selection of the user's images. The same methods described above can be utilized to identify the key words in the lyrics, the appropriate correlation score, and the association of the images with those key words. In a photobook application, selected images would be displayed within close proximity to the printed lyric/poem key words. Important lyric key words drive the important images. Higher priority key words would tend to bring more emphasis to the images associated with those key words. So an important key word would indicate that the image should have special treatment such as a larger size relative to other images within the photobook.

It will be understood that, although specific embodiments of the invention have been described herein for purposes of illustration and explained in detail with particular reference to certain preferred embodiments thereof, numerous modifications and all sorts of variations may be made and can be effected within the spirit of the invention and without departing from the scope of the invention. Accordingly, the scope of protection of this invention is limited only by the following claims and their equivalents.

### Parts List

6 digital camera
10 personal computer
12 databus
14 CPU
16 read-only memory
18 network connection device
20 hard disk drive
22 random access memory
24 display interface device
26 audio interface device
28 desktop interface device
30 CD-R/W drive
32 DVD drive
34 USB interface device
40 DVD-based removable media such as DVD R− or DVD R+
42 CD-based removable media such as CD-ROM or CD-R/W
44 mouse
46 keyboard
48 microphone
50 speaker
52 video display
60 network

1. A computer implemented method for producing a multimedia presentation, comprising the steps of:
providing to a computer system, text of a composition that is read or sung in a corresponding audio file;
automatically searching metadata associated with media to identify those media that correspond to at least one word or phrase of the composition text, wherein the identified media comprises video and still images; and
automatically simultaneously displaying the identified media while playing the corresponding audio file.

2. The method of claim 1 wherein the media are stored on the computer-accessible memory system, and wherein the step of searching metadata includes the step of searching metadata stored in the computer-accessible memory system.

3. The method of claim 1 wherein the audio file is stored in a computer-accessible memory system and wherein the step of displaying the identified media includes the step of displaying the identified media on a display device.

4. The method of claim 1 further comprising the step of ranking the identified media based at least on:
the strength of the identified media relevance to at least one word or phrase in the composition text,
the quality of the identified media, or both the strength of the identified media relevance to at least one word or phrase in the composition text and the quality of the identified media.

5. The method of claim 1 wherein the step of ranking the words or phrases in the composition text further comprises the step of counting a number of occurrences of the words or phrases in the composition text.

6. The method of claim 1 wherein the step of ranking the words or phrases in the composition text further comprises the step of determining whether the words or phrases appear in a title of the composition text.

7. The method of claim 1 further comprising the step of ranking the words or phrases from the composition text according to their vocal emphasis as read or sung in the corresponding audio file of the composition text.

8. The method of claim 7 wherein the step of ranking the words or phrases from the composition text further comprises the step of detecting a voice inflection in the audio file reading or singing of the words or phrases.

9. The method of claim 1 wherein the identified media is displayed for words or phrases in the composition text for varying display durations.

10. The method of claim 1 wherein the media are not stored on the computer system containing composition text and wherein the metadata is searched on a network to which the computer system is connected.

11. A computer system comprising:
storage for text of a composition that is read or sung in a corresponding audio file, the corresponding audio file stored in the storage, wherein the storage also stores a plurality of media each having associated metadata stored therewith, and wherein the media comprise video and still images;
a programmed processor for searching the metadata associated with the media to identify those media that correspond to at least one word or phrase of the composition text; and
a display device under control of the programmed processor for simultaneously displaying the identified media while playing the corresponding audio file.

12. The computer system of claim 11 wherein the display device is a personal digital assistant (PDA), cell phone, digital picture frame, digital projection, or monitor.

13. A program storage device readable by a computer that embodies a program of instructions executable by the computer to perform method steps for generating a multimedia presentation, said method steps comprising:
reading and storing text of a composition that is read or sung in a corresponding audio file;
automatically searching metadata associated with media to identify those media that correspond to at least one word or phrase of the composition text, wherein the identified media comprises video and still images; and
automatically simultaneously displaying the identified media while playing the corresponding audio file.

14. The program storage device of claim 13 wherein the media are stored on the computer used to read the program of instructions, and wherein the step of automatically searching metadata includes the step of automatically searching metadata stored on that computer.

15. The program storage device of claim 13 wherein the audio file is stored on the computer used to read the program of instructions, and wherein the step of simultaneously displaying the identified media includes the step of simultaneously displaying the identified media on a display device coupled to the computer.

16. The program storage device of claim 13 wherein the program of instructions provides a step of ranking the identified media based on:
the strength of identified media relevance to the at least one word or phrase in the composition text,
the quality of the identified media, or
both the strength of identified media relevance to the at least one word or phrase in the composition text and the quality of the identified media.

17. The program storage device of claim 13 wherein the program of instructions provides a step of ranking individual words or phrases from the composition text according to their vocal emphasis as read or sung in the corresponding audio file of the composition text.

18. The program storage device of claim 13 wherein the program of instructions provides:
a step of ranking individual words or phrases from the composition text according to a number of occurrences of the individual words or phrases in the composition text,
a step of determining whether the words or phrases appear in a title of the composition text, or
both steps.

19. The program storage device of claim 13 wherein the program of instructions provides a step of displaying identified media for various words or phrases in the composition text for different display durations.
